(19) United States
(12) Patent Application Publication
(10) Pub. No.: US 2017/0198761 A1
(43) Pub. Date: Jul. 13, 2017

(54) BI-DIRECTIONAL WEDGE CLUTCH WITH MUTUALLY SUPPORTING WEDGE PLATES

(71) Applicant: Schaeffler Technologies AG & Co. KG, Herzogenaurach (DE)

(72) Inventors: Marion Jack Ince, Mt. Holly, NC (US); Guihui Zhong, Charlotte, NC (US)

(21) Appl. No.: 14/994,597

(22) Filed: Jan. 13, 2016

(51) Int. Cl. F16D 41/066

(52) U.S. Cl. CPC F16D 41/066

(57) ABSTRACT

A wedge clutch, including: first and second hubs; outer ring located radially outward of the hubs; a first wedge plate between the first hub and the outer ring and including a first plurality of segments, each segment in the first plurality of segments separately formed from remaining segments in the first plurality of segments; a second wedge plate between the second hub and the outer ring and including a second plurality of separate segments, each segment in the second plurality of segments separately formed from remaining segments in the second plurality of segments; and a displacement assembly arranged to for a connect mode, axially displace the hubs with respect to each other to non-rotatably connect the hubs to the outer ring and for a disconnect mode, axially displace the hubs with respect to each other to enable rotation between the outer ring and the hubs.

### TECHNICAL FIELD

Described herein is a bi-directional wedge clutch with mutually supporting wedge plates. In particular, the wedge clutch includes two hubs with complimentarily sloping surfaces engaged with respective wedge plates and wedge plates made up of circumferentially adjacent and separate segments. The wedge plates contacting each other during torque transmission by the wedge clutch. The contact eliminates deflection of the wedge plates. The segments ensure uniform engagement about the circumference of the wedge plates.

### BACKGROUND

FIG. 12 is a front view of prior art bi-directional wedge clutch 200 with hub 202 and wedge plate 204. Hub 202 includes ramps 206A and 206B and wedge plate 204 includes ramps 208A and 208B and circumferential gap 210. Wedge plate 202 is biased radially outward to an outer race (not shown). When hub 202 receives torque in direction CD1, hub 202 rotates with respect to wedge plate 204 and the outer race. This relative rotation causes ramps 206A to slide up ramps 208A, expanding wedge plate 204 radially outward to non-rotatably connect hub 202 with the outer race via the wedge plate. However, since only every other ramp for the wedge plate is transmitting torque from the hub to the outer race, in this example ramps 206A, wedge plate 204 distorts, reducing the contact between the wedge plate and the outer ring. Further, contact between the wedge plate and the hub is compromised, resulting in undesired noise. Also, due to gap 210, wedge plate 204 does not expand evenly in the radially outer direction, exacerbating the contact, distortion and noise problems noted above. The distortion and contact problems cause the outer circumference of wedge plate 204 to lift off the surface of the outer ring, resulting in point contact between the wedge plate and the outer ring. The point contact can damage the wedge plate and outer ring and reduce the torque-carrying capacity of clutch 200.

### SUMMARY

According to aspects illustrated herein, there is provided a wedge clutch, including: an axis of rotation; a first hub; a second hub; an outer ring located radially outward of the first and second hubs; a first wedge plate radially disposed between the first hub and the outer ring and including a first plurality of segments, each segment in the first plurality of segments separately formed from remaining segments in the first plurality of segments; a second wedge plate radially disposed between the second hub and the outer ring and including a second plurality of separate segments, each segment in the second plurality of segments separately formed from remaining segments in the second plurality of segments; and a displacement assembly arranged to for a connect mode, axially displace the first and second hubs with respect to each other to non-rotatably connect the first and second hubs to the outer ring and for a disconnect mode, axially displace the first and second hubs with respect to each other to enable rotation between the outer ring and the first and second hubs.

According to aspects illustrated herein, there is provided a wedge clutch, including: an axis of rotation; a first hub; a second hub; an outer ring located radially outward of the first and second hubs; a first wedge plate radially disposed between the first hub and the outer ring and including a first plurality of segments, each segment in the first plurality of segments separately formed from remaining segments in the first plurality of segments; a second wedge plate radially disposed between the second hub and the outer ring and including a second plurality of separate segments, each segment in the second plurality of segments separately formed from remaining segments in the second plurality of segments; a first resilient element urging the first wedge plate radially inward; a second resilient element urging the second wedge plate radially inward; and a displacement assembly arranged to for a connect mode, axially displace the first and second hubs with respect to each other to non-rotatably connect the first and second hubs to the outer ring and for a disconnect mode, axially displace the first and second hubs with respect to each other to enable rotation between the outer ring and the first and second hubs.

According to aspects illustrated herein, there is provided a wedge clutch, including: an axis of rotation; a first hub; a second hub; an outer ring located radially outward of the first and second hubs; a first wedge plate radially disposed between the first hub and the outer ring and including a first plurality of segments, each segment in the first plurality of segments separately formed from remaining segments in the first plurality of segments; a second wedge plate radially disposed between the second hub and the outer ring and including a second plurality of separate segments, each segment in the second plurality of segments separately formed from remaining segments in the second plurality of segments; a first resilient element urging the first wedge plate radially inward; a second resilient element urging the second wedge plate radially inward; and a displacement assembly arranged to for a connect mode, axially displace the first and second hubs with respect to each other to non-rotatably connect the first and second hubs to the outer ring and for a disconnect mode, axially displace the first and second hubs with respect to each other to enable rotation between the outer ring and the first and second hubs. Each segment in the first plurality of segments includes a respective portion aligned, in an axial direction parallel to the axis of rotation, with a respective segment in the second plurality of segments.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a cylindrical coordinate system demonstrating spatial terminology used in the present application;

FIG. 2 is a front view of a wedge clutch with axially displaceable hubs; FIG. 3 is a rear view of the wedge clutch shown in FIG. 2;

FIG. 4 is a partial cross-sectional view of the wedge clutch shown in FIG. 2 during initiation of a connect mode;

FIG. 5 is a partial cross-sectional view of the wedge clutch in FIG. 2 upon completion of the connect mode;

FIG. 6 is a partial cross-sectional view of the wedge clutch shown in FIG. 2 in a disconnect mode;

FIG. 7 is a cross-sectional view generally along line 7-7 in FIG. 4;

FIG. 8 is a cross-sectional view generally along line 8-8 in FIG. 4;

FIG. 9A is a front view of overlapping wedge plate segments in FIG. 2;

FIG. 9B is a back view of overlapping wedge plate segments in FIG. 3;

FIG. 10A is a front view of a wedge plate segment in FIG. 2;

FIG. 10B is a back view of a wedge plate segment in FIG. 3;

FIG. 11 is a cross-sectional view generally along line 11-11 in FIG. 9A; and,

FIG. 12 is a front view of a prior art wedge plate for a wedge clutch.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

Unless defined otherwise, all technical and scientific terms used herein have the same meaning as commonly understood to one of ordinary skill in the art to which this present disclosure belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

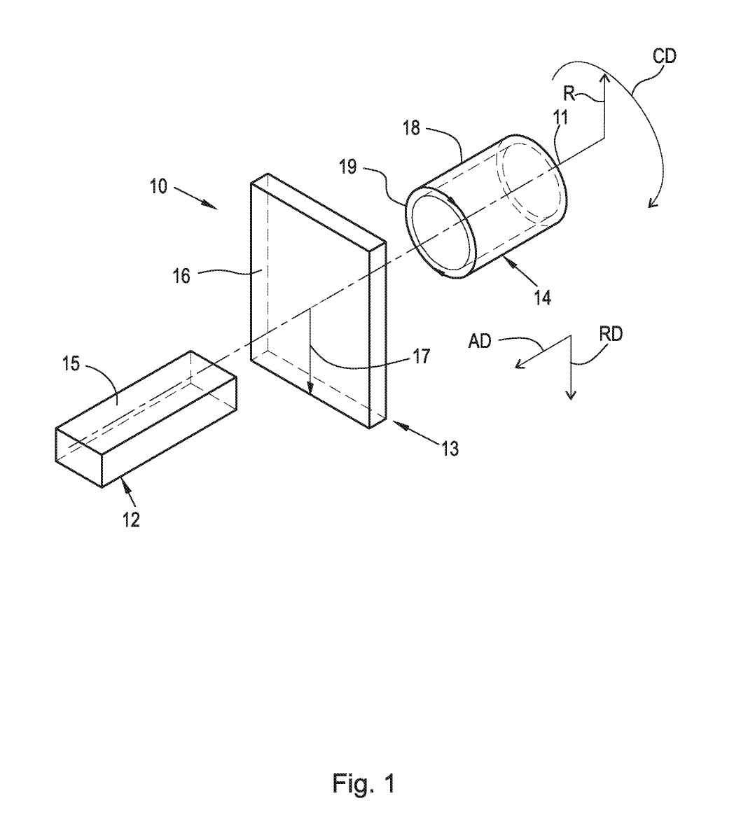

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 is passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

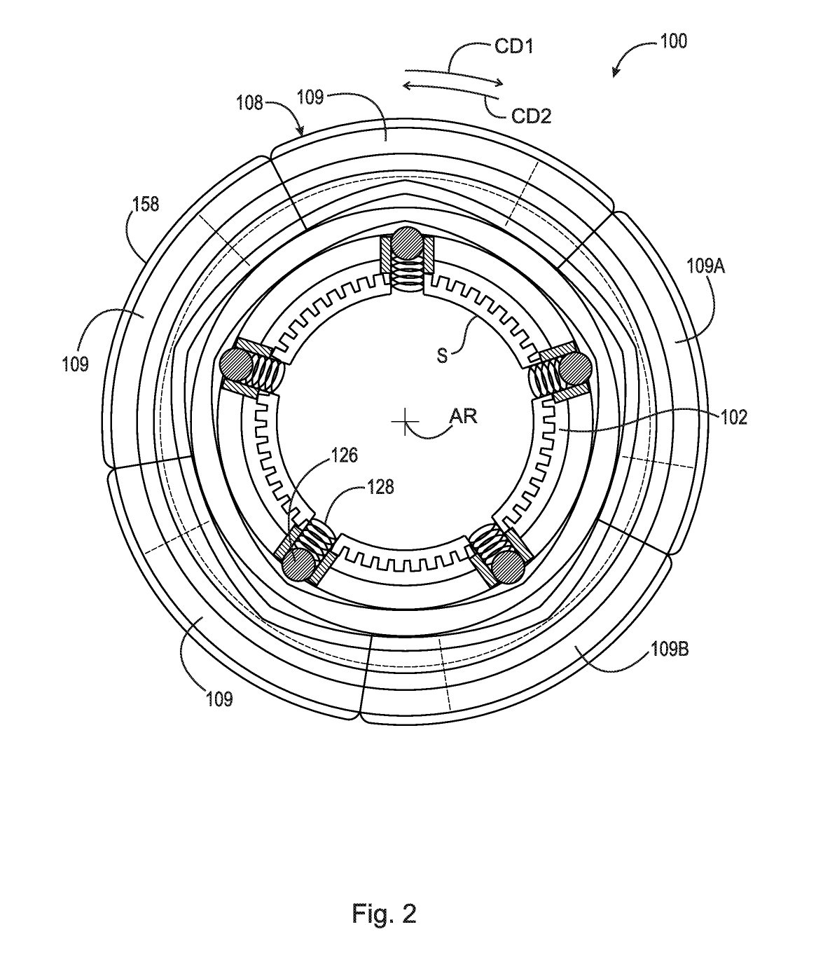

FIG. 2 is a front view of wedge clutch 100 with axially displaceable hubs.

FIG. 3 is a rear view of wedge clutch 100 shown in FIG. 2. The following should be viewed in light of FIGS. 2 and 3. Wedge clutch 100 includes: axis of rotation AR; hub 102; hub 104; outer ring 106 located radially outward of hubs 102 and 104; wedge plate 108 including segments 109; wedge plate 110 including segments 111; and displacement assembly 112. Wedge plate 108 is radially disposed between hub 102 and outer ring 106 and wedge plate 110 is radially disposed between hub 104 and outer ring 106.

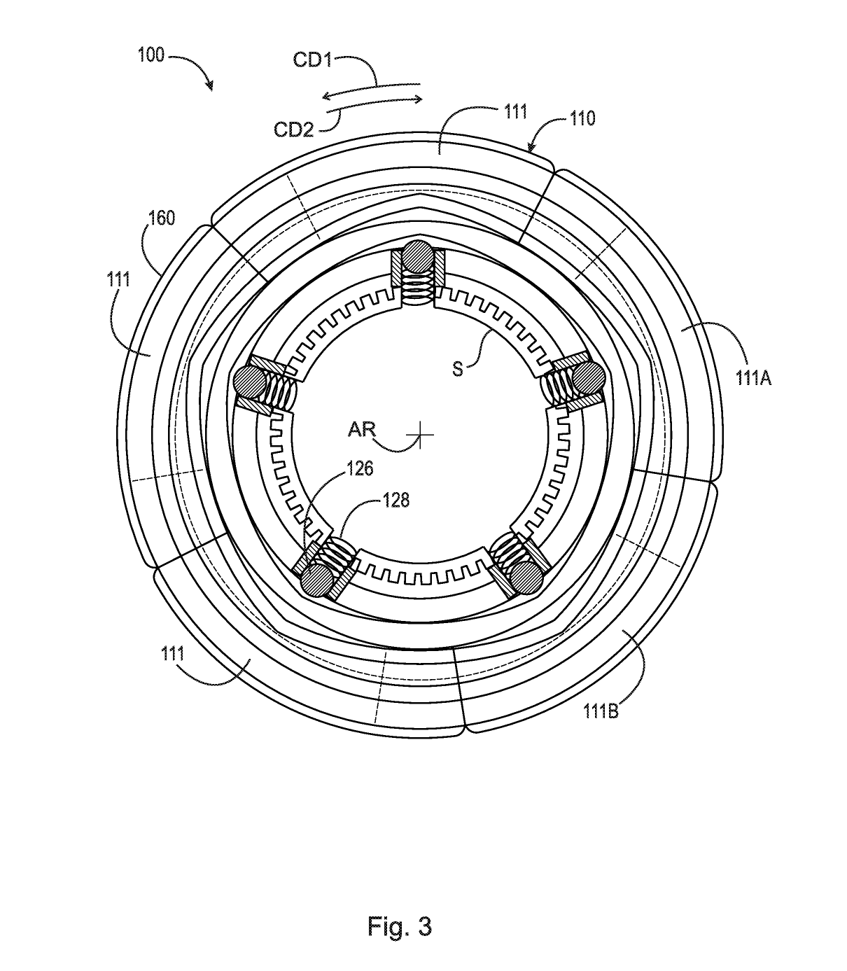

FIG. 4 is a partial cross-sectional view of wedge clutch 100 shown in FIG. 2 at initiation of a connect mode.

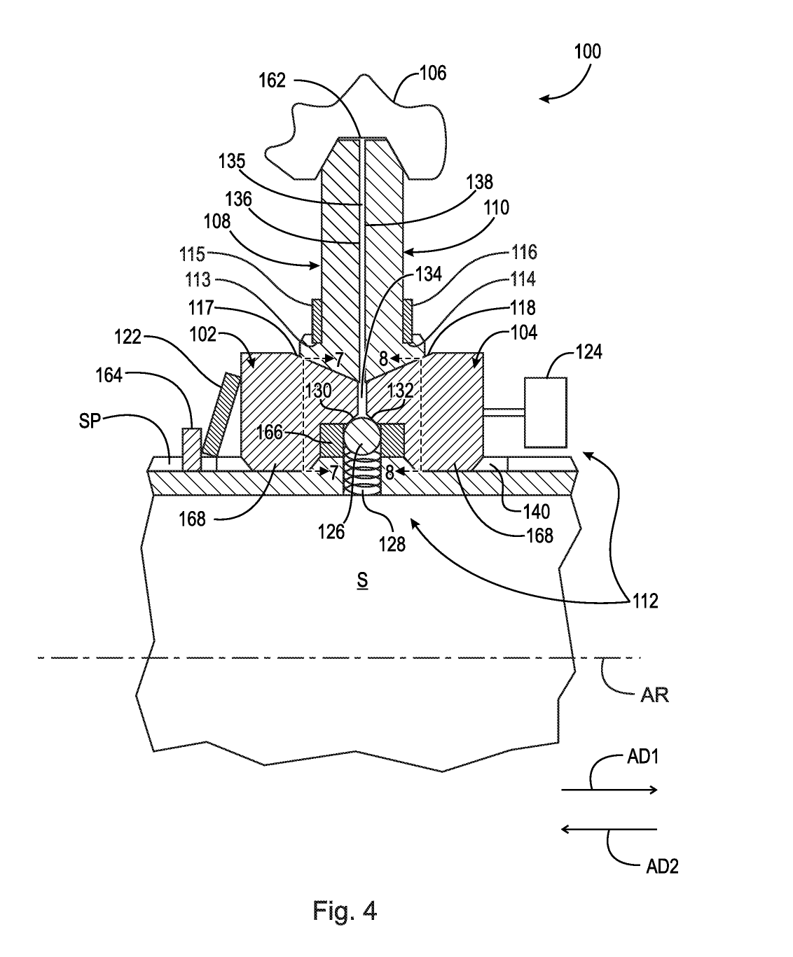

FIG. 5 is a partial cross-sectional view of wedge clutch 100 shown in FIG. 2 at completion of the connect mode.

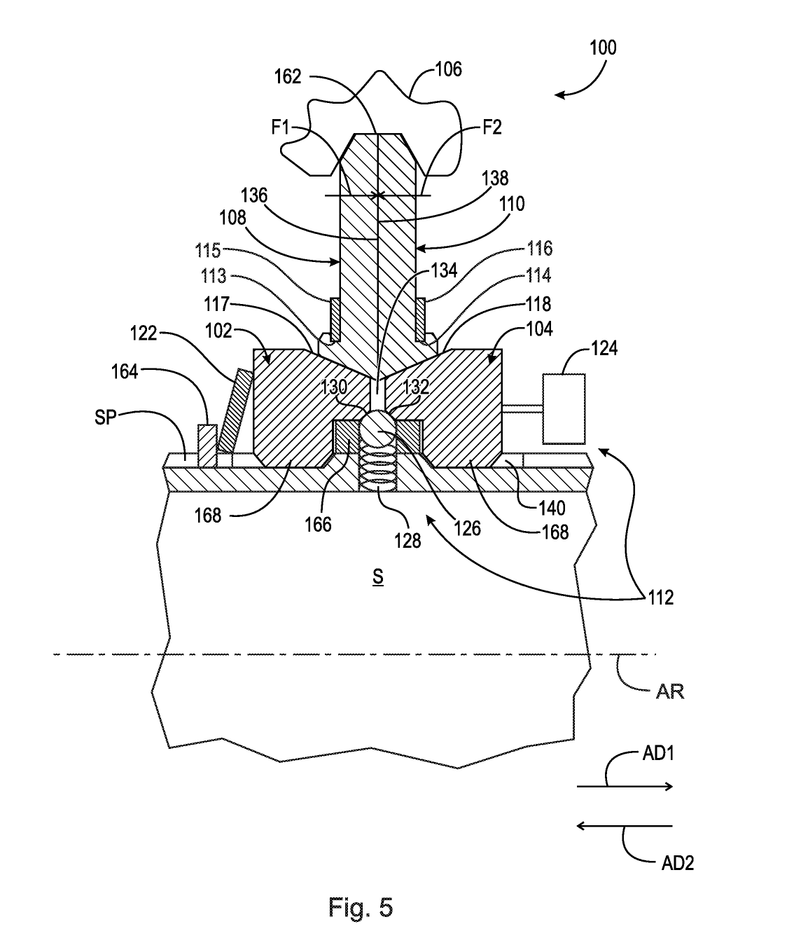

FIG. 6 is a partial cross-sectional view of wedge clutch 100 shown in FIG. 2 in a disconnect mode. The following should be viewed in light of FIGS. 2 through 6. For a connect mode for clutch 100, displacement assembly 112 is arranged to axially displace hub 102 and hub 104 with respect to each other to non-rotatably connect hub 102 and hub 104 to outer ring 106. For a disconnect mode, displacement assembly 112 is arranged to axially displace hub 102 and hub 104 with respect to each other to enable rotation between outer ring 106 and hubs 102 and 104.

In an example embodiment, for the connect mode, displacement assembly 112 is arranged to axially displace hub 102 and hub 104 toward each other. In an example embodiment, for the disconnect mode, displacement assembly 112 is arranged to axially displace hub 102 and hub 104 away from each other.

Each segment 109 includes a respective circumferentially extending groove 113. Each segment 111 includes a respective second circumferentially extending groove 114. Wedge clutch 100 includes annular resilient elements (rings) 115 and 116. Element 115 is disposed grooves 111 and urges segments 108 radially inward into contact with hub 102. Element 116 is disposed grooves 114 and urges segments 110 radially inward into contact with hub 104.

In an example embodiment: hub 102 includes surface 117 sloping in axial direction AD1 and engaged with wedge plate 108, for example, surface 117 is in contact with wedge plate 108; and hub 104 includes surface 118 sloping in axial direction AD2, opposite AD1, and engaged with wedge plate 110, for example, surface 118 is in contact with wedge plate 110. In an example embodiment: surface 117 slopes radially inward toward hub 104; and surface 118 slopes radially inward toward hub 102.

For the disconnect mode: surfaces 117 and 118 are arranged to slide along wedge plate 108 and wedge plate 110, respectively; and, wedge plate 108 and wedge plate 110 are arranged to displace radially inward, for example, creating gap 119 between wedge plate 108 and outer ring 106 and gap 120 between wedge plate 110 and outer ring 106.

In an example embodiment, displacement assembly 112 includes: element 122 urging hub 102 in axial direction AD1; element 124; element 126 disposed between the hub 102 and hub 104 in axial direction AD1 or AD2; and resilient element 128. In an example embodiment, element 126 is a ball. For the disconnect mode: element 124 is arranged to displace hub 104 in the axial direction AD1; resilient element 128 is arranged to displace element 126 radially outward; and element 126 is arranged to displace hub 102 in axial direction AD2. For the connect mode: element 124 is arranged to displace hub 104 in axial direction AD2; and hub 102 and hub 104 are arranged to displace element 126 radially inward.

In an example embodiment: hub 102 includes surface 130 sloping radially outward toward hub 104; and hub 104 includes surface 132 sloping radially outward toward hub 102. For the connect mode, surfaces 130 and 132 are arranged to displace element 126 radially inward. Thus, as hub 104 displaces in direction AD2 and element 122 urges hub 102 in direction AD1, surfaces 130 and 132 squeeze element 126 and force element 126 radially inward, decreasing axial gap 134 between hub 102 and hub 104 and axial gap 135 between plates 108 and 110. In an example embodiment, in the connect mode, gap 135 disappears, for example, surfaces 136 and 138 of wedge plates 108 and 110, respectively, are in contact.

For the disconnect mode, element 126 is arranged to displace radially outward along surfaces 130 and 132. As hub 104 displaces in direction AD1, element 128 is able to displace element 126 radially outward into axial gap 134. Once hub 104 has displaced a specified amount in direction AD1, for example, further displacement in direction AD1 is blocked by stop 140, hub 104 is blocked from displacing further in direction AD1. Since hub 104 is axially fixed, element 126 slides radially outward along surface 132, which pushes element 126 in direction AD2. Since element 126 is also in contact with surface 130, surface 130 and hub 102 also are displaced in direction AD2, increasing gap 134.

In an example embodiment, element 122 is a resilient element. In an example embodiment, element 124 is an actuator selected from the group consisting of a mechanical actuator, a hydraulic actuator, an electrical actuator and a pneumatic actuator.

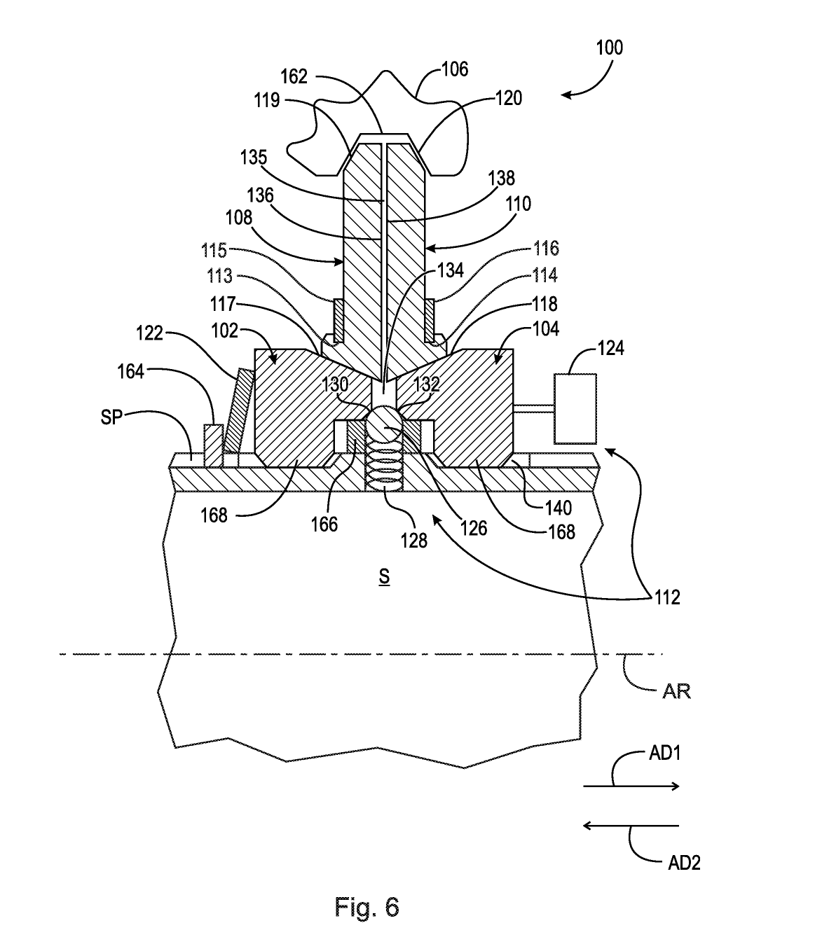

FIG. 7 is a cross-sectional view generally along line 7-7 in FIG. 4.

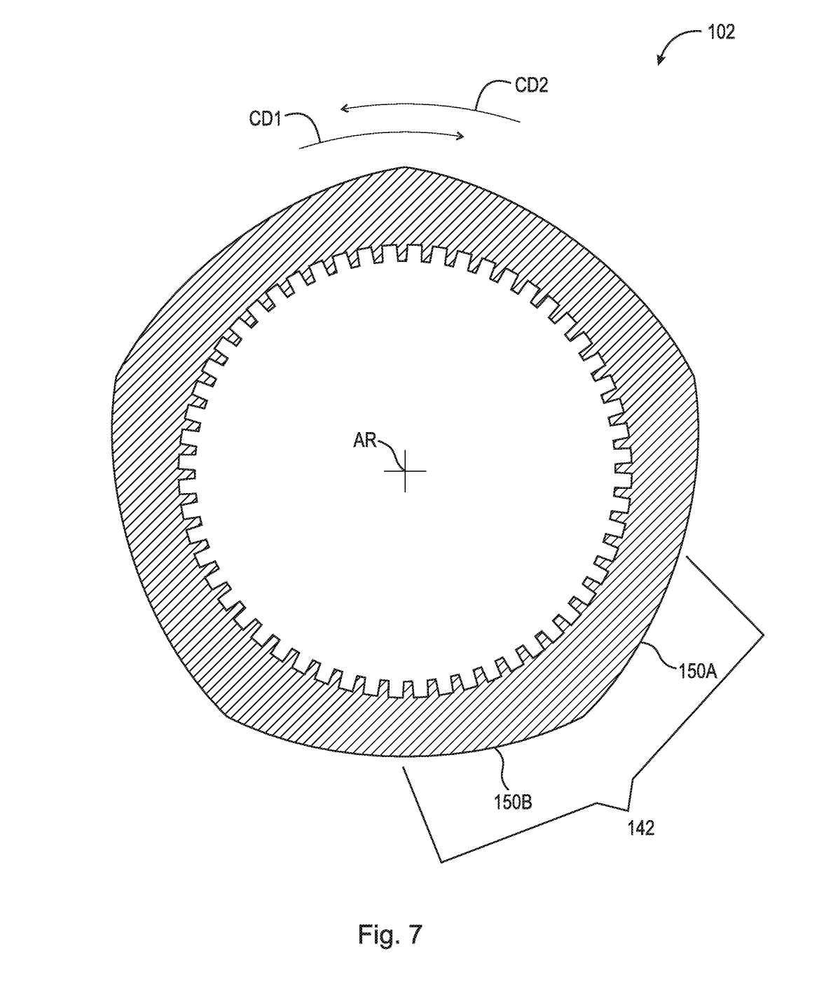

FIG. 8 is a cross-sectional view generally along line 8-8 in FIG. 4.

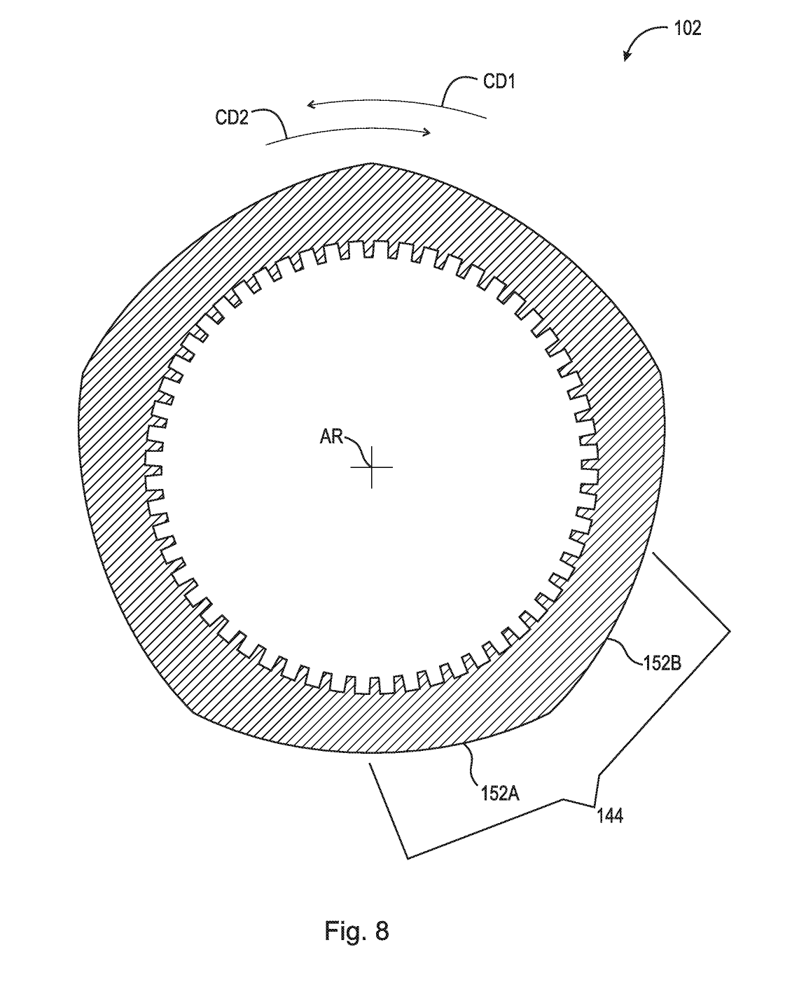

FIG. 9A is a front view of overlapping wedge plate segments in FIG. 2.

FIG. 9B is a back view of overlapping wedge plate segments in FIG. 3.

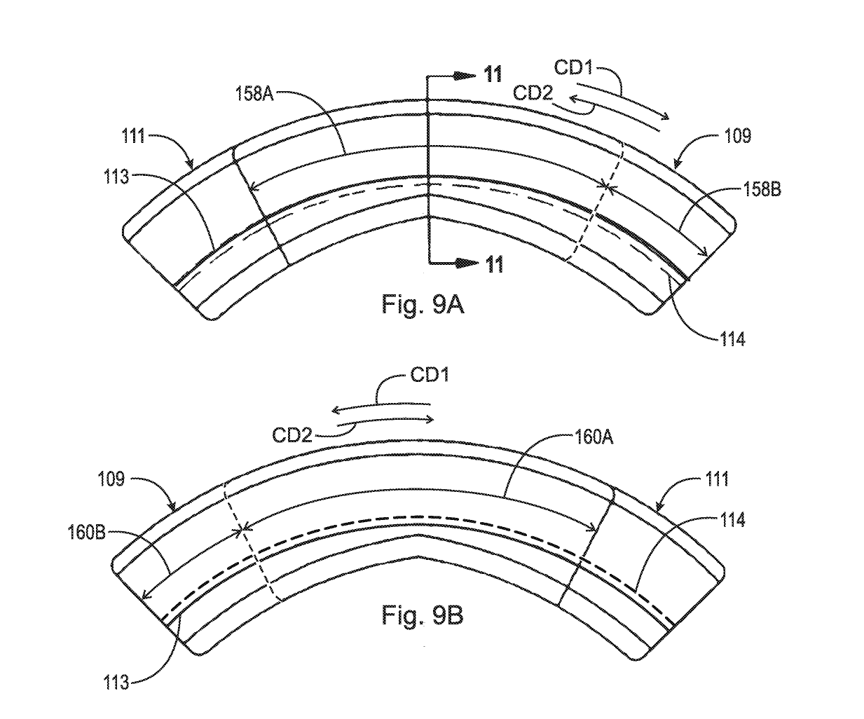

FIG. 10A is a front view of a wedge plate segment 108 in FIG. 2;

FIG. 10B is a back view of a wedge plate segment 110 in FIG. 3.

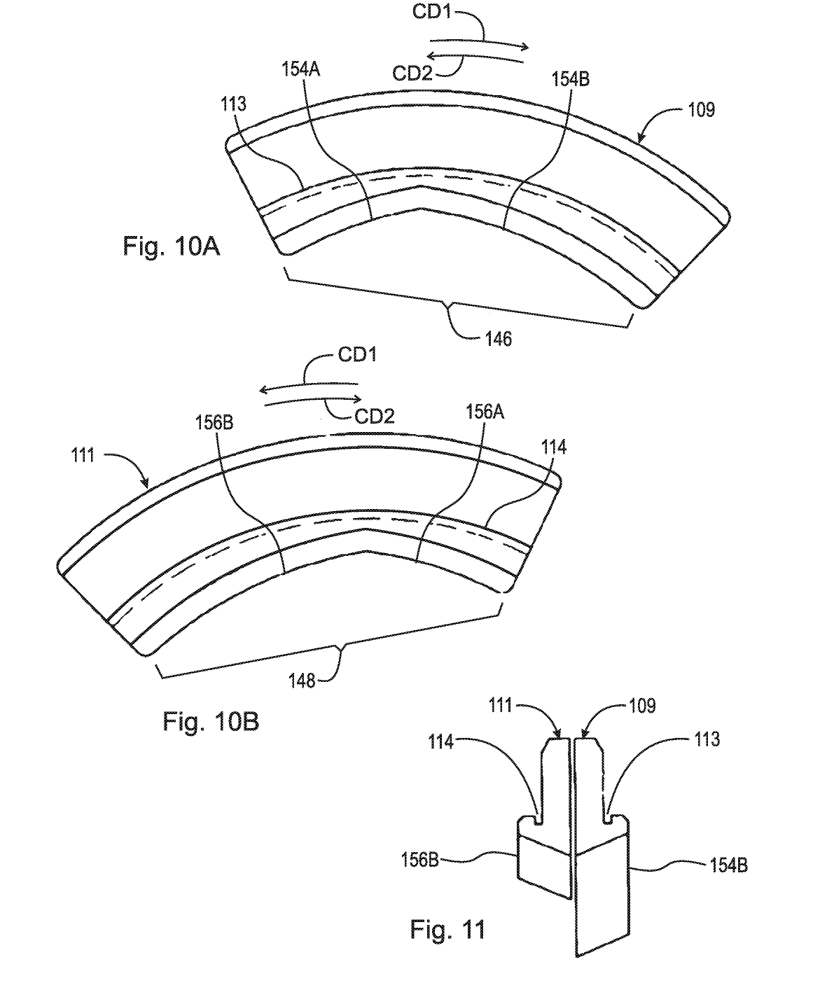

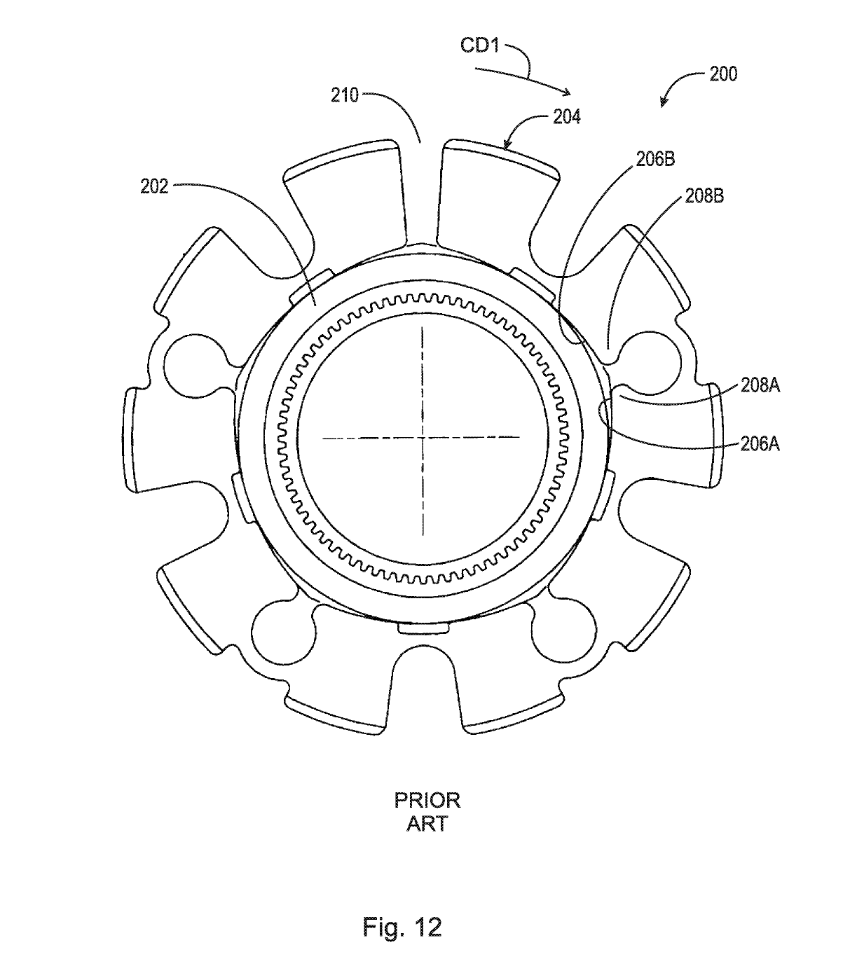

FIG. 11 is a cross-sectional view generally along line 11-11 in FIG. 9A. The following should be viewed in light of FIGS. 2 through 11. In an example embodiment: hub 102 includes ramps, for example, ramp pairs 142; hub 104 includes ramps, for example ramp pairs 144; wedge plate 108 includes ramps, for example ramp pairs 146; and wedge plate 110 includes ramps, for example ramp pairs 148. Each ramp pair 142 includes ramp 150A extending radially outward in circumferential direction CD1 and ramp 150B extending radially outward in circumferential direction CD2. Each ramp pair 144 includes ramp 152A extending radially outward in circumferential direction CD1 and ramp 152B extending radially outward in circumferential direction CD2. Each ramp pair 146 includes ramp 154A extending radially outward in circumferential direction CD1 and ramp 154B extending radially outward in circumferential direction CD2. Each ramp pair 148 includes ramp 156A extending radially inward in circumferential direction CD1 and ramp 156B extending radially inward in circumferential direction CD2. Each ramp 150A is engaged with a respective ramp 154A. Each ramp 150B is engaged with a respective ramp 154B. Each ramp 152A is engaged with a respective ramp 156A. Each ramp 152B is engaged with a respective ramp 156B.

In an example embodiment: each segment 109 includes portion 158A aligned, in axial direction AD1 or AD2, with a respective segment 111; and each segment 111 includes portion 160A aligned, in axial direction AD1 or AD2, with a respective segment 109. In an example embodiment: each segment 109 includes portion 158B not aligned, in axial direction AD1 or AD2, with the respective segment 111; and each segment 111 includes portion 160B not aligned, in axial direction AD1 or AD2, with the respective segment 109. That is, wedge plates 108 and 110 are circumferentially offset so that pairs of segments 109 and 111 only overlap partially in direction AD1 or AD2.

Segments 109 include circumferentially adjacent segments, for example, segments 109A and 109B, and segments 111 include circumferentially adjacent segments, for example, segments 111A and 111B. For example, to transition from the disconnect mode to the connect mode: segments 109A and 109B are arranged to displace radially outward and away from each other in direction CD1 or CD2; and segments 111A and 111B are arranged to displace radially outward and away from each other in direction CD1 or CD2. For example, to transition from the connect mode to the disconnect mode: segments 109A and 109B are arranged to displace radially inward and toward each other in direction CD1 or CD2; and segments 111A and 111B are arranged to displace radially inward and toward other in direction CD1 or CD2.

In an example embodiment, in the disconnect mode: at least one segment 109 is in contact with a circumferentially adjacent segment 109; and at least one segment 111 is in contact with a circumferentially adjacent segment 111. In an example embodiment, in the connect mode: at least one segment 109 is free of contact with a circumferentially adjacent segment 109; and at least one segment 111 is free of contact with a circumferentially adjacent segment 111.

The following provides further detail regarding the structure and function of wedge clutch 100. Note that torque can be applied to either hubs 102 and 104 for transmission to ring 106 or to ring 106 for transmission to hubs 102 and 104. For example, to initiate the connected mode as shown in FIG. 4, torque is applied to hubs 102 and 104 in direction CD1 and hubs 102 and 104 are axially displaced toward each other. As hubs 102 and 104 axially displace toward each other, wedge plates 108 and 110 slide radially outwardly along surfaces 114 and 116, respectively. Outer circumferential surfaces 158 and 160 of segments 109 and 111, respectively, frictionally engage inner circumferential surface 162 of ring 106. Hubs 102 and 104 and wedge plates 108 and 110 are rotating relative to ring 106 in direction CD1. Therefore, the frictional engagement of plates 108 and 110 with ring 106 causes plates 108 and 110 to rotate with respect to hubs 102 and 104, respectively, causing ramps 150A and 152A to slide radially outwardly (slide up or climb) along ramps 154A and 156A, respectively, which in turn causes wedge plates 108 and 110 to expand radially outward. The radially outward expansion of wedge plates 108 and 110 causes wedge plates 108 and 110 to non-rotatably connect to ring 106 and to hubs 102 and 104.

As full torque is applied, the connection mode is completed as shown in FIG. 5. The application of the torque from hubs 102 and 104 to wedge plates 108 and 110, respectively, results in a radially inward compressive force that causes wedge plates 108 and 110 to slide down (radially inwardly) along surfaces 117 and 118, respectively, until sides 136 and 138 come into contact.

To initiate the disconnect mode shown in FIG. 6, hubs 102 and 104 are axially displaced away from each other and wedge plates 108 and 110 slide down surfaces 117 and 118, respectively, creating gaps 119 and 120. Since there is no contact between wedge plates 108 and 110 and ring 106, ring 106 and hubs 102 and 104 are able to rotate independently of each other. When the compressive force on wedge plates 108 and 110, associated with the connected mode, is released, wedge plates 108 and 110 slide down ramp pairs 142 and 144, respectively.

The discussion for torque applied in direction CD1 is applicable to torque applied in direction CD2. For example, to initiate the connected mode as shown in FIG. 4, torque is applied to hubs 102 and 104 in direction CD2 and hubs 102 and 104 are axially displaced toward each other. As hubs 102 and 104 axially displace toward each other, wedge plates 108 and 110 slide radially outwardly along surfaces 117 and 118, respectively. Outer circumferential surfaces 158 and 160 of segments 109 and 111, respectively, frictionally engage inner circumferential surface 162 of ring 106. Hubs 102 and 104 and wedge plates 108 and 110 are rotating relative to ring 106 in direction CD2. Therefore, the frictional engagement of plates 108 and 110 with ring 106 cause plates 108 and 110 to rotate with respect to hubs 102 and 104, respectively, causing ramps 150B and 152B to slide radially outwardly (slide up or climb) along ramps 154B and 156B, respectively, which in turn causes wedge plates 108 and 110 to expand radially outwardly. The radially outward expansion of wedge plates 108 and 110 causes wedge plates 108 and 110 to non-rotatably connect to ring 106 and to hubs 102 and 104. The discussion for the disconnect mode and torque in direction CD1 is applicable to the disconnect mode for torque in direction CD2.

Note that the above discussion regarding application of torque through hubs 102 and 104 is applicable to application of torque through ring 106.

In an example embodiment, element 122 is blocked from displacement in direction AD2 by snap ring 164. In an example embodiment, element 126 is contained in retainer 166. Wedge plate 100 can be non-rotatably connected to shaft S, for example by splines 168 on hubs 102 and 104 interleaved with splines SP of shaft.

Advantageously, wedge clutch 100 resolves the problem noted above of non-uniform engagement of wedge plates in a wedge clutch. In particular, segments 109 and 111 are uniformly engaged with and compressed between hubs 102 and 104 and ring 106 when clutch 100 is in the connect mode. The following discussion is directed to plate 108, segments 109, and ring 115; however, it should be understood that the discussion is applicable to plate 110, segments 111, and ring 116 as well. Each segment 109 is a separate piece of material. Segments 109 are free of a fixed connection to circumferentially adjacent segments 109, but are retained and biased radially inward by ring 115. Ring 115 also reduces noise caused by unwanted movement of segments 109. Thus, each segment 109 is free to displace radially inward and outward (orthogonal to axis AR) independently and equally, which results in full and uniform contact of surfaces 158 of segments 109 with surface 162 of outer ring 106 during the connect mode.

In an example embodiment, segments 109 and 111 are circumferentially offset from each other as shown in FIGS. 9A and 9B. This offset is such that, for example when torque is applied to hubs 102 and 104 in one of directions CD1 or CD2, the torque contact is towards the approximate centerline of one set of segments although both sets of segments carry the torque. Then, when torque is applied to hubs 102 and 104 in the other of directions CD1 or CD2, the torque contact is towards the approximate centerline of the other set of segments although both sets of segments carry the torque. For example, for torque in direction CD1, the approximate centerline is for segments 109 and for torque in direction CD2, the approximate centerline is for segments 111.

Advantageously, wedge clutch 100 resolves the problem noted above of wedge plates deflecting under load. During full torque loading of wedge clutch 100, deflection forces F1 and F2 work to deflect wedge plates 108 and 110 in directions AD1 and AD2 respectively, for example, due to the slope of surfaces 114 and 116. However, as shown in FIG. 5, during full torque-loading of wedge clutch 100, wedge plates 108 and 110 come into contact and forces F1 and F2 neutralize each other. Thus, wedge plates 108 and 110 do not deflect and the full and uniform contact noted above is attained and maintained.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A wedge clutch, comprising:
an axis of rotation;
a first hub;
a second hub;
an outer ring located radially outward of the first and second hubs;
a first wedge plate radially disposed between the first hub and the outer ring and including a first plurality of segments, each segment in the first plurality of segments separately formed from remaining segments in the first plurality of segments;
a second wedge plate radially disposed between the second hub and the outer ring and including a second plurality of separate segments, each segment in the second plurality of segments separately formed from remaining segments in the second plurality of segments; and,
a displacement assembly arranged to:
for a connect mode, axially displace the first and second hubs with respect to each other to non-rotatably connect the first and second hubs to the outer ring; and,
for a disconnect mode, axially displace the first and second hubs with respect to each other to enable rotation between the outer ring and the first and second hubs.

2. The wedge clutch of claim 1, wherein:
each segment in the first plurality of segments includes a respective first circumferentially extending groove; and,
each segment in the second plurality of segments includes a respective second circumferentially extending groove, the wedge clutch further comprising:
a first annular resilient element disposed in the respective first circumferentially extending grooves and urging the first plurality of segments radially inward; and,
a second annular resilient element disposed in the respective second circumferentially extending grooves and urging the second plurality of segments radially inward.

3. The wedge clutch of claim 1, wherein:
each segment in the first plurality of segments includes a respective first plurality of ramps;
the first hub includes a second plurality of ramps engaged with the respective first pluralities of ramps;
each segment in the second plurality of segments includes a respective third plurality of ramps;
the second hub includes a fourth plurality of ramps engaged with the respective third pluralities of ramps; and,
for the connect mode:
the respective first pluralities of ramps are arranged to slide radially outwardly along the second plurality of ramps, in a first circumferential direction; and,
the respective third pluralities of ramps are arranged to slide radially outwardly along the fourth plurality of ramps, in the first circumferential direction.

4. The wedge clutch of claim 3, wherein:
each respective first plurality of ramps includes a first pair of ramps;
the second plurality of ramps includes a plurality of second pairs of ramps, each second pair of ramps engaged with a respective first pair of ramps;
each respective third plurality of ramps includes a third pair of ramps;
the fourth plurality of ramps includes a plurality of fourth pairs of ramps, each fourth pair of ramps engaged with a respective third pair of ramps.

5. The wedge clutch of claim 4, wherein:
each respective first pair of ramps includes respective first and second ramps;
said each second pair of ramps includes third and fourth ramps engaged with the respective first and second ramps, respectively;
each respective third pair of ramps includes respective fifth and sixth ramps; and,
said each fourth pair of ramps includes seventh and eighth ramps engaged with the respective fifth and sixth ramps, respectively.

6. The wedge clutch of claim 1, wherein said each segment in the first plurality of segments includes a respective portion aligned, in an axial direction parallel to the axis of rotation, with a respective segment in the second plurality of segments.

7. The wedge clutch of claim 6, wherein said each segment in the first plurality of segments includes a respective portion not aligned, in the axial direction, with the respective segment in the second plurality of segments.

8. The wedge clutch of claim 1, wherein:
the first plurality of segments includes first and second circumferentially adjacent segments;
the second plurality of segments includes third and fourth circumferentially adjacent segments; and,
to transition from the disconnect mode to the connect mode:
the first and second segments are arranged to displace away from each other in a circumferential direction; and,
the third and fourth segments are arranged to displace away from each other in the circumferential direction.

9. The wedge clutch of claim 1, wherein:
the first plurality of segments includes first and second circumferentially adjacent segments;
the second plurality of segments includes third and fourth circumferentially adjacent segments; and,
to transition from the connect mode to the disconnect mode:
the first and second segments are arranged to displace toward each other in a circumferential direction; and,
the third and fourth segments are arranged to displace toward each other in the circumferential direction.

10. The wedge clutch of claim 1, wherein in the disconnect mode:
at least one segment in the first plurality of segments is in contact with another segment in the first plurality of segments; and,
at least one segment in the second plurality of segments is in contact with another segment in the second plurality of segments.

11. The wedge clutch of claim 1, wherein:
for the connect mode:
the displacement assembly is arranged to axially displace the first and second hubs toward each other; and,
the first and second hubs are arranged to displace the first and second wedge plates, respectively, radially outward; and,
for the disconnect mode:
the displacement assembly is arranged to axially displace the first and second hubs axially away from each other; and,
the first and second wedge plates are arranged to displace radially inward.

12. The wedge clutch of claim 1, wherein:
the displacement assembly includes:
a first element urging the first hub in the first axial direction;
a second element;
a ball disposed between the first and second hubs in the first axial direction; and,
a first resilient element urging the ball radially outward;
for the connect mode:
the second element is arranged to displace the second hub in a second axial direction opposite the first axial direction; and,
the first and second hub are arranged to displace the ball radially inward; and,
for the disconnect mode, the first resilient element is arranged to displace the ball radially outward.

13. A wedge clutch, comprising:
an axis of rotation;
a first hub;
a second hub;
an outer ring located radially outward of the first and second hubs;
a first wedge plate radially disposed between the first hub and the outer ring and including a first plurality of segments, each segment in the first plurality of segments separately formed from remaining segments in the first plurality of segments;
a second wedge plate radially disposed between the second hub and the outer ring and including a second plurality of separate segments, each segment in the second plurality of segments separately formed from remaining segments in the second plurality of segments;
a first resilient element urging the first wedge plate radially inward;
a second resilient element urging the second wedge plate radially inward; and,
a displacement assembly arranged to:
for a connect mode, axially displace the first and second hubs with respect to each other to non-rotatably connect the first and second hubs to the outer ring; and,
for a disconnect mode, axially displace the first and second hubs with respect to each other to enable rotation between the outer ring and the first and second hubs.

14. The wedge clutch of claim 13, wherein:
each segment in the first plurality of segments includes a respective first circumferentially extending groove;
each segment in the second plurality of segments includes a respective second circumferentially extending groove;
the first resilient element is disposed in the respective first circumferentially extending grooves; and,
the second annular resilient element is disposed in the respective second circumferentially extending grooves.

15. The wedge clutch of claim 13, wherein:
each segment in the first plurality of segments includes a respective first plurality of ramps;
the first hub includes a second plurality of ramps engaged with the respective first pluralities of ramps;
each segment in the second plurality of segments includes a respective third plurality of ramps;
the second hub includes a fourth plurality of ramps engaged with the respective third pluralities of ramps; and,
for the connect mode:
the respective first pluralities of ramps are arranged to slide radially outwardly along the second plurality of ramps, in a first circumferential direction; and,
the respective third pluralities of ramps are arranged to slide radially outwardly along the fourth plurality of ramps, in the first circumferential direction.

16. The wedge clutch of claim 13, wherein:
the first hub includes pairs of first and second ramps;
the second hub includes pairs of third and fourth ramps;
each segment in the first plurality of segments includes a pair of fifth and sixth ramps engaged with a respective pair of first and second ramps;
each segment in the second plurality of segments includes a pair of seventh and eighth ramps engaged with a respective pair of third and fourth ramps.

17. The wedge clutch of claim 13, wherein:
each segment in the first plurality of segments includes a respective portion aligned, in an axial direction, parallel to the axis of rotation, with a respective segment in the second plurality of segments; and,
said each segment in the first plurality of segments includes a respective portion not aligned, in the axial direction, with the respective segment in the second plurality of segments.

18. The wedge clutch of claim 13, wherein in the disconnect mode:
at least one segment in the first plurality of segments is in contact with another segment in the first plurality of segments; and,
at least one segment in the second plurality of segments is in contact with another segment in the second plurality of segments.

19. The wedge clutch of claim 13, wherein:
the displacement assembly includes:
a first element urging the first hub in the first axial direction;
a second element;
a ball disposed between the first and second hubs in the first axial direction; and,
a first resilient element urging the ball radially outward;
for the connect mode:
the second element is arranged to displace the second hub in a second axial direction opposite the first axial direction; and,
the first and second hub are arranged to displace the ball radially inward; and,
for the disconnect mode, the first resilient element is arranged to displace the ball radially outward.

20. A wedge clutch, comprising:
an axis of rotation;
a first hub;
a second hub;
an outer ring located radially outward of the first and second hubs;
a first wedge plate radially disposed between the first hub and the outer ring and including a first plurality of segments, each segment in the first plurality of segments separately formed from remaining segments in the first plurality of segments;
a second wedge plate radially disposed between the second hub and the outer ring and including a second plurality of separate segments, each segment in the second plurality of segments separately formed from remaining segments in the second plurality of segments;
a first resilient element urging the first wedge plate radially inward;
a second resilient element urging the second wedge plate radially inward; and,
a displacement assembly arranged to:
for a connect mode, axially displace the first and second hubs with respect to each other to non-rotatably connect the first and second hubs to the outer ring; and,
for a disconnect mode, axially displace the first and second hubs with respect to each other to enable rotation between the outer ring and the first and second hubs, wherein:
each segment in the first plurality of segments includes a respective portion aligned, in an axial direction parallel to the axis of rotation, with a respective segment in the second plurality of segments.
